(19) United States
(12) Patent Application Publication
(10) Pub. No.: US 2011/0174335 A1
(43) Pub. Date: Jul. 21, 2011

(54) WASHING APPARATUS & SYSTEM

(75) Inventors: Andrew John Crimston, Dural (AU); Alexander George Bailey, Tanja (AU)

(73) Assignee: Geosentinel Pty Ltd, Hurlstone Park (AU)

(21) Appl. No.: 13/060,482

(22) PCT Filed: Aug. 26, 2009
(86) PCT No.: PCT/AU2009/001103

§ 371 Date: Apr. 11, 2011

(30) Foreign Application Priority Data
Aug. 27, 2008 (AU) 2008904413

(51) Int. Cl. B08B 3/10; B08B 3/00

(52) U.S. Cl. 134/10; 134/109

(57) ABSTRACT

A washing apparatus for washing trades equipment. The apparatus comprises at least one washing receptacle for holding or supporting trades equipment to be washed; at least three tanks each of which is in fluid communication with said receptacle; a first pump for pumping substantially clean water from any of the three tanks to a water outlet above the receptacle and a second pump for pumping wash-water from the receptacle to any of the three tanks, wherein in use whilst wash-water is being chemically treated for separation into sedimentary waste and substantially clean water in one of the three tanks, substantially clean water may be pumped by the first pump from a second of the three tanks to the receptacle via the water outlet for washing equipment in the receptacle, and wash-water leaving the receptacle may be pumped by the second pump to a third of the three tanks.

### TECHNICAL FIELD

The present invention relates to a washing apparatus and/or system for washing contaminated trade tools and other equipment. The present invention is primarily described with an apparatus and system for washing painting equipment such as paint brushes, paint rollers, spray gun nozzles and fittings, paint trays and the like. However, it should be understood that the washing apparatus and system of the present invention could be used to wash other trades equipment, such as that used by concreters, tilers, renderers, plasterboard installers and the like.

### BACKGROUND

When a painting task is finished or at the end of a work day, many painters, typically clean their tools of the trade such as paint brushes, paint rollers and spray guns with a water hose in a basin. The wash water from the paint equipment typically drains from the basin into the sewer or onto the ground. This practice is both detrimental to the environment and a waste of water.

In some jurisdictions it is illegal to allow wash-water used to clean paint equipment and other trades equipment into the sewer. Accordingly professional painters, building sites and the like who generate large amounts of wash-water, employ third party contractors to remove and dispose of wash-water in an environmentally friendly manner. As it is quite expensive to handle such contaminated wash-water, a number of prior art devices/systems are known to separate waste from wash-water, thereby allowing contractors to only cart the waste away from site, and possibly allow for the recycling of the treated water.

One such prior art system is described in AU2004100677 (Enviro Solutions Pty Ltd). This system utilises a basin (upper wash structure) in which paint equipment is washed. A settlement tank is disposed below the basin and is used to catch wash-water. A flocculant is added to the settlement tank for the purposes of separating the wash-water into a sediment of paint solids and relatively clean water. The seperation process may take up to 24 hours and results in sediment at the bottom of the settlement tank that may be drawn off for disposal, whilst the separated water may be re-used.

Another prior art system is the Reclaimer System (Mk1 Reticulated) marketed in Australia by RA Industries. In this system the paint equipment is washed in a washout tank that collects the wash-water. Flocculant and coagulant are added to the washout tank, then agitated and allowed to settle, thereby separating the wash-water into a sediment of paint solids and relatively clean water. The sediment is removed and the relatively clean water can either be discharged to sewage or recycled.

One of the disadvantages of the prior art systems is that operators and users of such systems, may under certain circumstances not allow for wash-water to be properly treated. This may typically occur on building sites where a large amount of wash-water needs to be continually treated. When pressured due to work load, some users may discharge the treated wash-water before the separation process is complete. This results in poor recycling of water, and in some instances only 30-40% of the water is re-used.

This occurs because the tank being used for chemically treating the wash-water, may interfere or prevent with further cleaning of equipment to take place whilst chemical treatment is taking place.

The present invention seeks to overcome at least one of the disadvantages of the prior art.

### SUMMARY OF THE INVENTION

According to a first aspect the present invention consists in a washing apparatus for washing trades equipment, said apparatus comprising at least one washing receptacle for holding or supporting trades equipment to be washed; at least three tanks each of which is in fluid communication with said receptacle; a first pump for pumping substantially clean water from any of said three tanks to a water outlet above said receptacle and a second pump for pumping wash-water from said receptacle to any of said at least three tanks, wherein in use whilst wash-water is being chemically treated for separation into sedimentary waste and substantially clean water in one of said three tanks, substantially clean water may be pumped by said first pump from a second of said three tanks to said receptacle via said water outlet for washing equipment in said receptacle, and wash-water leaving said receptacle may be pumped by said second pump to a third of said three tanks.

Preferably said three tanks are supported by a first base.

Preferably said three tanks are adjacent to each other.

Preferably each of said tanks has an access hole in its lower portion to allow for removal of sedimentary waste.

Preferably said first base has a support structure for supporting said receptacle, and said receptacle is a wash basin.

Preferably said first base has recesses for fork-lift access to allow lifting thereof.

Preferably said receptacle is a large item receptacle for the cleaning of large items.

Preferably said large item receptacle has a removable grate.

Preferably said large item receptacle has an interior large enough to be accessed by at least a shovel, to allow for removal of solid matter that may have been captured therein.

Preferably said large item receptacle has is supported by a second base.

Preferably said second base has recesses for fork-lift access to allow lifting thereof.

Preferably said large item receptacle comprises at least one splash screen.

Preferably a control system is operably connected to said tanks and said first and second pumps for controlling the filling and emptying of said tanks.

Preferably said control system controlling the sequence of the tanks to be employed for chemical treatment and substantially clean water draw-off.

Preferably said chemical treatment comprises the addition of a flocculant to said wash-water.

Preferably said trades equipment is painting equipment.

According to a second aspect the present invention consists in a trades equipment washing apparatus comprising: at least one washing receptacle for holding or supporting trades equipment to be washed; a first pump for pumping substantially clean water and a second pump for pumping wash-water; a plurality of tanks each of which is in fluid communication with said receptacle and each capable of collecting wash-water therefrom via said second pump, and wherein in use wash-water in any of said tanks may be chemically treated for separation into sedimentary waste and substantially clean water, and said substantially clean water from any of said tanks may be pumped to said receptacle via a water outlet for washing equipment in said receptacle.

Preferably said apparatus is portable.

According to a third aspect the present invention consists in a trades equipment washing system using substantially recycled water, said system comprising: at least one washing receptacle for holding or supporting trades equipment to be washed; a first pump for pumping substantially clean water and a second pump for pumping wash-water; a plurality of tanks each of which is in fluid communication with said receptacle and capable of collecting wash-water therefrom via said second pump, each tank able to be used for the chemical treatment of wash-water to produce sedimentary waste solids and substantially clean water; and a water outlet disposed at or near said receptacle for delivering substantially clean water for washing equipment in said receptacle from any of said tanks via said first pump.

According to a fourth aspect the present invention consists in a method of washing trades equipment using substantially recycled water, wherein a plurality of tanks are each sequentially used to collect and chemically treat wash-water from at least one washing receptacle in which the trades equipment is cleaned, wherein in-use the substantially clean water which is the result of chemically treated water in a first of said tanks is used to clean trades equipment in said washing receptacle with the wash-water therefrom being pumped to a second of said tanks for chemical treatment.

Preferably whilst said substantially clean water is being drawn from the first of said tanks and said wash-water is being pumped to the second of said tanks, the wash-water in at least a third tank is undergoing chemical treatment for separation into sedimentary waste and substantially clean water.

Preferably substantially clean water is pumped via via first pump and wash-water is pumped by a second pump.

### BRIEF DESCRIPTION OF THE DRAWINGS

A preferred embodiment of the invention will now be described, by way of example only, with reference to the accompanying drawings in which:

FIG. 1 is a perspective view of an embodiment of a washing apparatus for washing trades equipment in accordance with the present invention.

FIG. 2 is a perspective view of the washing apparatus of FIG. 1, with the location of two pumps shown in phantom lines.

FIG. 3 is an enlarged rear view of the washing apparatus of FIG. 1.

FIG. 4a is a perspective view of the washing apparatus of FIG. 1, with the flow paths of “substantially clean water” to and from a first pump.

FIG. 4b is a perspective view of the washing apparatus of FIG. 1, with the flow paths of “wash-water” to and from a second pump.

### BEST MODE OF CARRYING OUT INVENTION

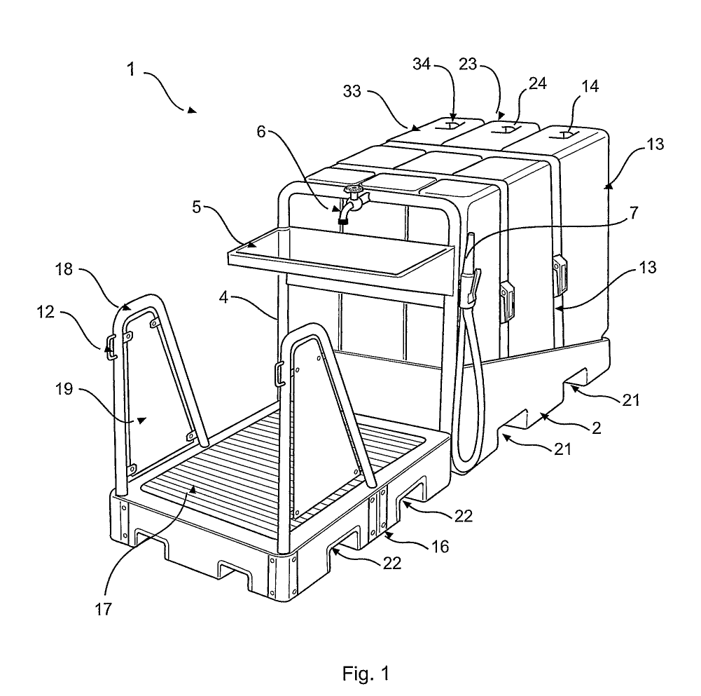

FIGS. 1 to 4(b) depict an embodiment of a washing apparatus 1 for washing trades equipment such as paint equipment. Washing apparatus 1 comprises three adjacent separate tanks 13, 23 and 33 supported by a base 2, and preferably held in place by retaining means such as cargo straps 3.

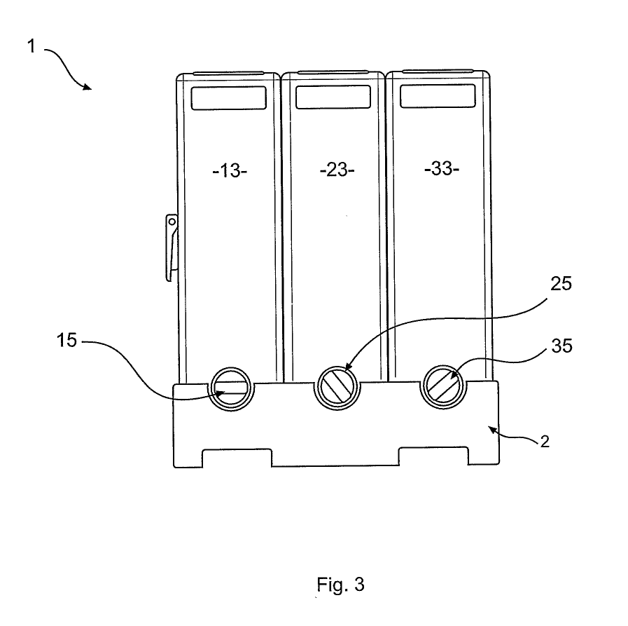

Each tank 13, 23 and 33 is about 300 litres and preferably made out of rotationally moulded plastic material such as polyethylene. Each tank 13, 23 and 33 has a respective upper access hole 14, 24, 34 and respective rear access holes 15, 25, 35 near its bottom, see FIG. 3.

Base 2 may also be made of a plastic material, and may be provided with recesses 21 for fork-lift access. The front end of base 2 has an upwardly projecting support frame 4 that supports a wash basin 5 in which to wash paint equipment, and a tap 6 and trigger hose 7 to provide “substantially clean water”. The water that becomes contaminated with paint or other chemicals during the washing process and which leaves basin 5 will in this specification be referred to as “wash-water”.

In this specification “substantially clean water” is either mains tap water or chemically treated (recycled) water.

The washing apparatus 1 may also optionally be provided with a separate large trades equipment wash receptacle 16, that has its upper opening covered by a grate 17. The height of this wash receptacle 16 is substantially less than the wash basin 5, thereby making it easy to lift and place large items onto grate 17.

Receptacle 16 allows for large trade items such as wheel barrows, shovels, large paint trays and the like to be washed with trigger-hose 7 without having to lift them to the height of basin 5. Receptacle 16 may be provided with recesses 22 for fork-lift access. The grate 17 is preferably sized to prevent particles of a size greater than about 15 mm to enter receptacle 16. Receptacle 16 is provided with side frames 18 that each support splash screens 19 made of plastic, such as polycarbonate or polypropylene. Attachment lugs 12 on frames 18 may be used to support chains (not shown) for restraining large items during washing.

Preferably, wash receptacle 16, with grate 17 removed therefrom, has an interior/opening large enough to be accessed by a shovel or other means, to allow for removal of solid matter that may have been captured therein.

Each tank 13, 23 and 33 is capable of receiving wash-water for chemical treatment by a flocculant additive and possibly the addition of a coagulant. Such chemical treatment typically requires anywhere between 2-24 hours to allow the wash-water to seperate into a substantially clean water layer above a flocculated paint (or other waste) sediment. Once chemical treatment occurs this paint (or other waste) sediment is a minimal layer occupying only about 5-15% of the bottom of the tank. Once treatment has occured in any of tanks 13, 23 and 33 the paint (or other waste) sediment may be removed therefrom via the the respective rear access holes 15, 25 and 35.

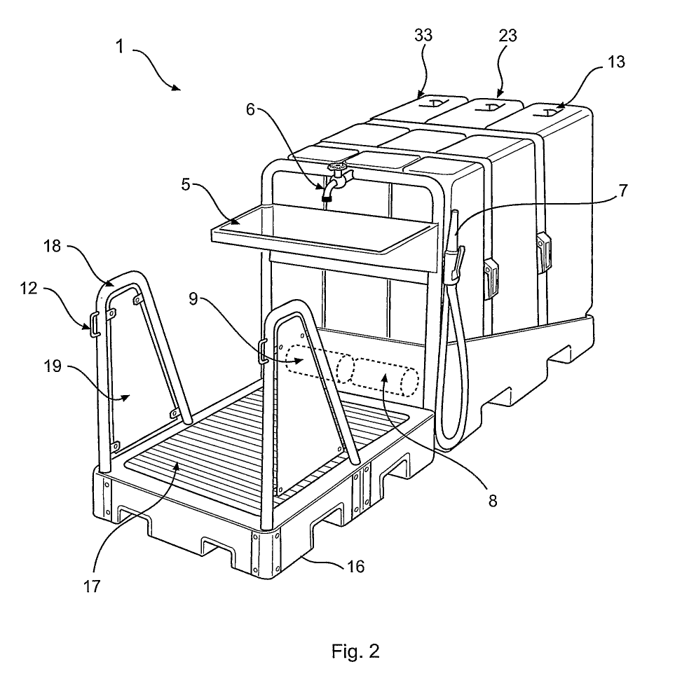

As shown schematically by phantom lines in FIG. 2, washing apparatus 1 has a first pump 8 and a second pump 9, disposed near the front of base 2. The first pump 8 is for pumping “substantially clean water” and the second pump is for pumping “wash-water”.

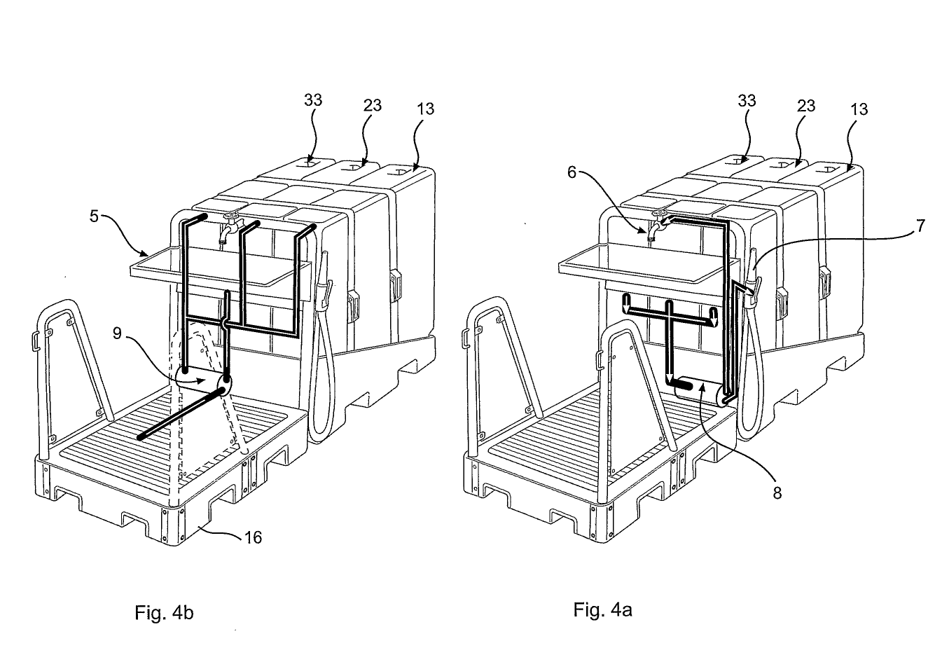

For clarity and ease of reference the basic flow circuits of first pump 8 and second pump 9 are shown separately in FIGS. 4(a) and 4(b), respectively. With reference to FIG. 4(a), pump 8 is able to pump “substantially clean water” from any one of tanks 13, 23 and 33 and deliver it to either of the water outlets, namely tap 6 or trigger hose 7.

With reference to FIG. 4(b), pump 9 is able to pump “wash-water” from basin 5 and/or receptacle 16 to any of tanks 13, 23, and 33. The wash-water from basin 5 is fed to pump 9 via gravity. Likewise, due to a downward slope (not shown) on the interior surface of receptacle 16, wash-water therefrom is also fed to pump 9 via gravity.

The receptacle 16 is separately transportable to washing apparatus 1, however in use it may be placed and restrained in front of washing apparatus 1 as shown in FIG. 1 and operably connected to pump 9.

At first use of washing apparatus 1, tanks 13 and 33 may be filled with mains tap water via their respective upper access holes 14 and 34, whilst tank 23 is left empty. When paint or other trades equipment is to be washed in either or both basin 5 and receptacle 16, the water is pumped via pump 8 to either or both of tap 6 and trigger hose 7. After cleaning the resultant wash-water is gravity fed from basin 5 and/or receptacle 16 to pump 9 where it is pumped into tank 23. When tank 23 is substantially full of wash-water, the flocculant and any other desirable additive may be added to the tank for chemical treatment. At this point, tank 13 is now substantially empty as it provided the initial water for cleaning purposes.

Whilst wash-water in tank 23 is undergoing chemical treatment, paint or other trades equipment may be washed in basin 5 and/or receptacle 16 with water pumped by pump 8 from tank 33. The resultant wash-water is now pumped by pump 9 to the substantially empty tank 13. When tank 13 is substantially full of wash-water, flocculant and any other desirable additive may be added to the tank 13 for chemical treatment. At this point, tank 33 is now substantially empty.

Once wash-water in tank 23 has undergone treatment and thereby separated into substantially clean water and sediment, the substantially clean water therein may now be drawn off via pump 8 for washing paint or other trades equipment, with the resultant wash-water being pumped via pump 9 to the now substantially empty tank 33.

This sequence may then occur cyclically, so that whilst wash-water is being chemically treated in one of the tanks, the substantially clean water drawn from previously treated wash-water may be used for cleaning purposes, with the resultant wash-water being fed to a substantially empty tank.

The water in apparatus 1 can be in any one of three states, namely:
(i) “substantially clean water” (either tap water or chemically treated/recycled water),
(ii) “wash-water” (contaminated after the washing process); and
(iii) “waste water” (after flocculation, and drawing-off substantially clean water). This is a small portion of water that gets pumped out of the system completely via second pump 9.

After waste water is drawn from the tank for removal from the apparatus 1 by second pump 9, there is a facility for the waste water to be dewatered prior to leaving apparatus 1, with the excess water in this process process being returned to the system.

The advantage of this apparatus 1 (and system) is that wash-water being chemically treated in one tank does not interfere or substantially hold up the washing process. A further advantage, is that this apparatus (and system) can achieve a water re-cycling efficiency of about 90-95%, with minimal risk that a user will dump water being chemically treated due to work-load pressure.

The paint (or other waste) sediment layers may periodically be removed from tanks 13, 23 and 33 via the the respective rear access holes 15, 25 and 35.

It should be understood that the location of the draw-off outlet for substantially clean water in each tank 13, 23 and 33 to be delivered to pump 8, should be at a level well above the bottom of the tank to ensure that it is above the flocculated paint (or other waste) sediment layer that settles at the bottom. This draw-off outlet should preferably not be in the lowermost 20% of the tank.

It should also be understood that the washing apparatus 1 may preferably be provided with a control system operably connected to tanks 13, 23 and 33, the pumps 8, 9 and the pipe work and valves (not shown) interconnecting the same, for the purpose of controlling the sequence of the tanks to be employed for chemical treatment and substantially clean water draw-off. Preferably the tanks are fitted with upper and lower level sensors/switches operably connected to the control system to control the filling and emptying of tanks.

Furthermore, the necessary flocculant and any other desirable additive may be manually added to the any of the tanks 13,23 and 33 when chemical treatment is required. However, it should be understood that in an alternative embodiment the flocculant and any desirable additive may be added to any of tanks 13, 23 and 33 by an automated dispensing device controlled by the abovementioned control system.

Furthermore, a control/display panel (not shown) may also be provided to allow users to operate and/or monitor the the processes carried out by the apparatus. This control/panel may also include means for recording and displaying water usage details.

In the abovementioned embodiment with tanks 13, 23 and 33 being about 300 litres, the base 2 has a width of about 1100 mm and the wash basin 5 has a height of about 950 mm. Likewise the width of the receptacle 16 is about 1100 mm, whilst its height is about 180 mm. These dimensions make the apparatus 1 and receptacle 16 both suitable for transport to a building or painting site by a small truck or utility vehicle.

An advantage of the three separate tanks 13, 23 and 33, is that if any of these tanks become damaged, blocked or require inspection, they may possibly each be removed from the base 2 and replaced, without the need to replace the others.

In the abovementioned embodiment the washing apparatus has three tanks however, in other not shown embodiments, more than three tanks, say possibly four or five tanks may be employed.

In the abovementioned embodiment the access holes 15, 25 and 35 that allow for removal of waste are accessible at the rear of tanks 13, 23 and 33. The contractors who remove the waste may have their own “pump apparatus” (not shown) attachable to tanks 13, 23 and 33 for pumping the waste out via access holes 15, 25 and 35. Alternatively, pump 9 that is used for pumping wash-water, may also have the dual function of being able to be used to pump out waste via access holes 15, 25 and 35. Also, in another not shown embodiment the access holes 15, 25 and 35 may possibly be at the front of the respective tanks 13,23 and 33 rather than the back. It should also be noted that regardless of the position of access holes 15, 25 and 35, the base of tanks 13,23 and 33 may have downward slopes that provide gravity assistance so that waste flows towards the inlet of the removal pump.

The terms “comprising” and “including” (and their grammatical variations) as used herein are used in inclusive sense and not in the exclusive sense of “consisting only of”.

1. A washing apparatus for washing trades equipment, said apparatus comprising at least one washing receptacle for holding or supporting trades equipment to be washed; at least three tanks each of which is in fluid communication with said receptacle; a first pump for pumping substantially clean water from any of said three tanks to a water outlet above said receptacle and a second pump for pumping wash-water from said receptacle to any of said three tanks, wherein in use whilst wash-water is being chemically treated for separation into sedimentary waste and substantially clean water in one of said three tanks, substantially clean water may be pumped by said first pump from a second of said three tanks to said receptacle via said water outlet for washing equipment in said receptacle, and wash-water leaving said receptacle may be pumped by said second pump to a third of said three tanks.

2. A washing apparatus as claimed in claim 1, wherein said three tanks are supported by a first base.

3. A washing apparatus as claimed in claim 2, wherein said three tanks are adjacent to each other.

4. A washing apparatus as claimed in 1, wherein each of said tanks has an access hole in its lower portion to allow for removal of sedimentary waste.

5. A washing apparatus as claimed in claim 2 wherein said first base has a support structure for supporting said receptacle, and said receptacle is a wash basin.

6. A washing apparatus as claimed in claim 2 wherein said first base has recesses for forklift access to allow lifting thereof.

7. A washing apparatus as claimed in claim 1, wherein said receptacle is a large item receptacle for the cleaning of large items.

8. A washing apparatus as claimed in claim 7, wherein said large item receptacle has a removable grate.

9. A washing apparatus as claimed in claim 8, wherein said large item receptacle has an interior large enough to be accessed by at least a shovel, to allow for removal of solid matter that may have been captured therein.

10. A washing apparatus as claimed in claim 8, wherein said large item receptacle is supported by a second base.

11. A washing apparatus as claimed in claim 10, wherein said second base has recesses for fork-lift access to allow lifting thereof.

12. A washing apparatus as claimed in claim 7, wherein said large item receptacle comprises at least one splash screen.

13. A washing apparatus as claimed in claim 1, wherein a control system is operably connected to said tanks and said first and second pumps for controlling the filling and emptying of said tanks.

14. A washing apparatus as claimed in claim 13, wherein said control system controlling the sequence of the tanks to be employed for chemical treatment and substantially clean water draw-off.

15. A washing apparatus as claimed in claim 1, wherein said chemical treatment comprises the addition of a flocculant to said wash-water.

16. A washing apparatus as claimed in claim 1, wherein said trades equipment is painting equipment.

17. A trades equipment washing apparatus comprising:
at least one washing receptacle for holding or supporting trades equipment to be washed; a first pump for pumping substantially clean water and a second pump for pumping wash-water; a plurality of tanks each of which is in fluid communication with said receptacle and each capable of collecting wash-water therefrom via said second pump, and wherein in use wash-water in any of said tanks may be chemically treated for separation into sedimentary waste and substantially clean water, and said substantially clean water from any of said tanks may be pumped to said receptacle via a water outlet for washing equipment in said receptacle.

18. A trades equipment washing apparatus as claimed in claim 17, wherein said apparatus is portable.

19. A trades equipment washing system using substantially recycled water, said system comprising:
at least one washing receptacle for holding or supporting trades equipment to be washed;
a first pump for pumping substantially clean water and a second pump for pumping wash-water;
a plurality of tanks each of which is in fluid communication with said receptacle and capable of collecting wash-water therefrom via said second pump, each tank able to be used for the chemical treatment of wash-water to produce sedimentary waste solids and substantially clean water; and
a water outlet disposed at or near said receptacle for delivering substantially clean water for washing equipment in said receptacle from any of said tanks via said first pump.

20. A method of washing trades equipment using substantially recycled water, wherein a plurality of tanks are each sequentially used to collect and chemically treat wash-water from at least one washing receptacle in which the trades equipment is cleaned, wherein in-use the substantially clean water which is the result of chemically treated water in a first of said tanks is used to clean trades equipment in said washing receptacle with the wash-water therefrom being pumped to a second of said tanks for chemical treatment.

21. A method of washing trades equipment using substantially recycled water as claimed in claim 20, wherein whilst said substantially clean water is being drawn from the first of said tanks and said wash-water is being pumped to the second of said tanks, the wash-water in at least a third tank is undergoing chemical treatment for separation into sedimentary waste and substantially clean water.

22. A method of washing trades equipment using substantially recycled water as claimed in claim 20, wherein substantially clean water is pumped via via first pump and wash-water is pumped by a second pump.
